(19) United States
(12) Patent Application Publication
(10) Pub. No.: US 2016/0202314 A1
(43) Pub. Date: Jul. 14, 2016

(54) TEST CIRCUIT AND METHOD OF SEMICONDUCTOR DEVICE

(71) Applicant: SK hynix Inc., Icheon-si Gyeonggi-do (KR)

(72) Inventor: Ho Sung CHO, Icheon-si Gyeonggi-do (KR)

(21) Appl. No.: 14/635,784

(22) Filed: Mar. 2, 2015

(30) Foreign Application Priority Data
Jan. 9, 2015 (KR) 10-2015-0003236

(51) Int. Cl. G01R 31/3177; H04L 9/08

(52) U.S. Cl. CPC G01R 31/3177; H04L 9/0897

(57) ABSTRACT

A test method of a semiconductor device may include receiving a first encrypted test program externally from the semiconductor device, decrypting the first encrypted test program based on an encryption key, and generating a first test signal by driving the decrypted first test program.

### CROSS-REFERENCES TO RELATED APPLICATION

The present application claims priority under 35 U.S.C. §119(a) to Korean application number 10-2015-0003236, filed on Jan. 9, 2015, in the Korean Intellectual Property Office, which is incorporated herein by reference in its entirety.

### BACKGROUND

1. Technical Field

Various embodiments generally relate to a semiconductor device, and more particularly, to the test circuit of a semiconductor device.

2. Related Art

The recent technology of a built-in self-test circuit (hereinafter referred to as a ‘BIST’) may now be included in a semiconductor device in order to efficiently test the semiconductor devices. The BIST may perform a test for a semiconductor device according to a series of test algorithms by autonomously driving a test program and storing or externally outputting test results. A semiconductor device does not need to include a plurality of channels for electrically coupling to external test equipment and the semiconductor device. The semiconductor device may perform tests under a high-speed operating environment according to a frequency because it may have the BIST embedded therein.

The BIST may receive a test program from an external apparatus or a user, may store the received test program, and may perform a test operation by driving the stored test program. Various test programs may be performed depending on a test pattern, and the test programs may include code for generating a test signal that controls the internal operations of a semiconductor device. A test program may inevitably be exposed to the outside when the test program is input to the BIST from an external apparatus. Accordingly, an analysis of a test program by a desirable user may lead to the leak of core technologies implemented in a semiconductor device.

### SUMMARY

According to an embodiment, a test method of a semiconductor device may include receiving a first encrypted test program externally from the semiconductor device, decrypting the first encrypted test program based on an encryption key, and generating a first test signal by driving the decrypted first test program.

According to an embodiment, a test circuit of a semiconductor device may include a decryption unit configured to receive an encrypted test program externally from the semiconductor device and decrypt the encrypted test program based on an encryption key, and a test execution unit configured to generate a test signal by driving the decrypted test program.

According to an embodiment, a test method of a semiconductor device may include generating a first encrypted test program by encrypting a test program using a first encryption key, storing the first encryption key in a first semiconductor device, and receiving the first encrypted test program externally from the semiconductor device by a test circuit located within the first semiconductor device.

### BRIEF DESCRIPTION OF THE DRAWINGS

FIG. 1 is a diagram illustrating an example of a representation of a test method for a semiconductor device in accordance with various embodiments.

FIG. 2 is an example of a representation of a schematic block diagram of the semiconductor device of FIG. 1.

FIG. 3 is an example of a representation of a block diagram of a BIST illustrated in FIG. 2.

FIG. 4 is a diagram illustrating an example of a representation of some elements of the BIST illustrated in FIG. 3.

FIG. 5 is a flowchart illustrating an example of a representation of a test method for the semiconductor device in accordance with various embodiments.

FIG. 6 is a flowchart illustrating an example of a representation of a method of maintaining the security for a semiconductor device in accordance with various embodiments.

FIGS. 7 and 8 are diagrams illustrating examples of representations of test methods for semiconductor devices in accordance with an embodiment.

FIG. 9 is a flowchart illustrating an example of a representation of a method of maintaining the security of the semiconductor device in accordance with an embodiment.

FIG. 10 illustrates a block diagram of an example of a representation of a system employing the semiconductor device in accordance with the embodiments discussed above with relation to FIGS. 1-9.

### DETAILED DESCRIPTION

Hereinafter, the test circuit of a semiconductor device and a test method using the same will be described below with reference to the accompanying drawings through various examples of embodiments.

Various embodiments may be directed to the provision of a test method capable of performing a test for a semiconductor device using an encrypted test program.

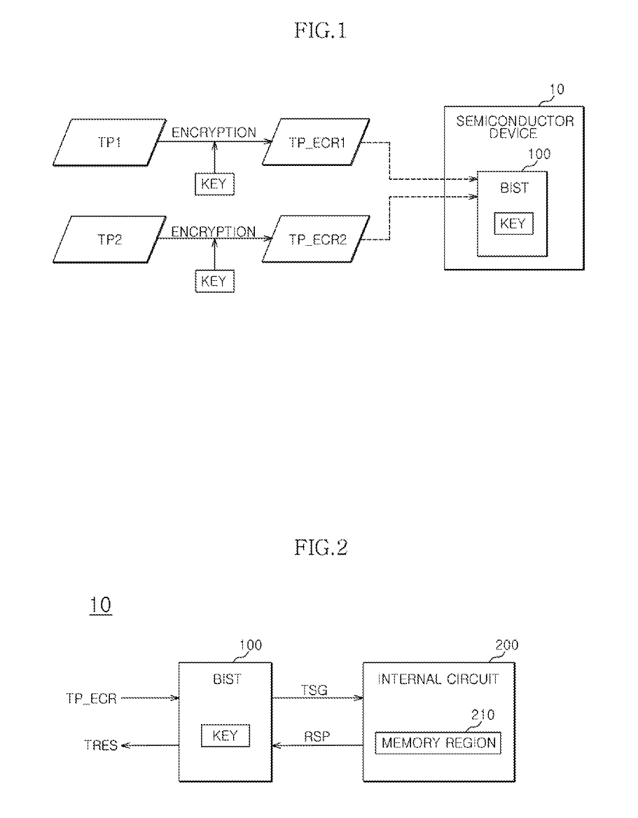

FIG. 1 is a diagram illustrating an example of a representation of a test method for a semiconductor device 10 in accordance with various embodiments.

In accordance with various embodiments, a test program TP1 and a test program TP2 may be converted into an encrypted test program TP_ECR1 and an encrypted test program TP_ECR2, respectively, through an encryption process. The test programs TP1 and TP2 may be encrypted using a specific encryption key KEY. The encryption key KEY may be stored in a test circuit 100. The test circuit 100 may be a built-in self-test circuit (BIST), for example. However, the embodiments are not limited to only the BIST. The BIST 100 may receive the encrypted test programs TP_ECR1 and TP_ECR2 from an external apparatus (i.e., external to the semiconductor device 10) in order to test a semiconductor device 10. The encrypted test programs TP_ECR1 and TP_ECR2 inputted into the BIST 100 may be decrypted using the encryption key KEY stored in the BIST 100. The BIST 100 may perform a decryption process on the encrypted test programs TP_ECR1 and TP_ECR2, and then perform a test for the semiconductor device 10 by driving a decrypted test program.

The test programs may vary depending on a test pattern. FIG. 1 illustrates the two test programs TP1 and TP2, for example. The test programs TP1 and TP2 may be encrypted using the respective encryption keys KEY. The encrypted test programs TP_ECR1 and TP_ECR2 may be input to the BIST 100 for tests according to variations in test patterns.

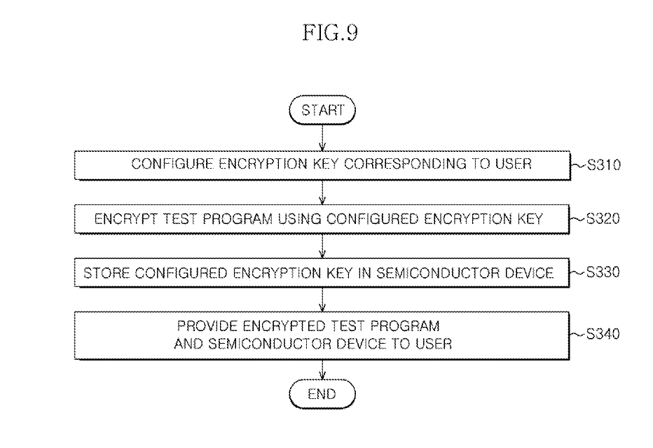

In some embodiments, different test programs TP1 and TP2 may be encrypted using different encryption keys. The encryption keys KEY may be configured differently depending on the different test programs TP1 and TP2, and further descriptions thereof will be described later with reference to FIG. 8.

An encrypted test program and the BIST capable of decrypting the encrypted test program may be effective in maintaining the security of a semiconductor device. A technology leak problem through an analysis of a test program can be effectively blocked because a user may be supplied with an encrypted test program.

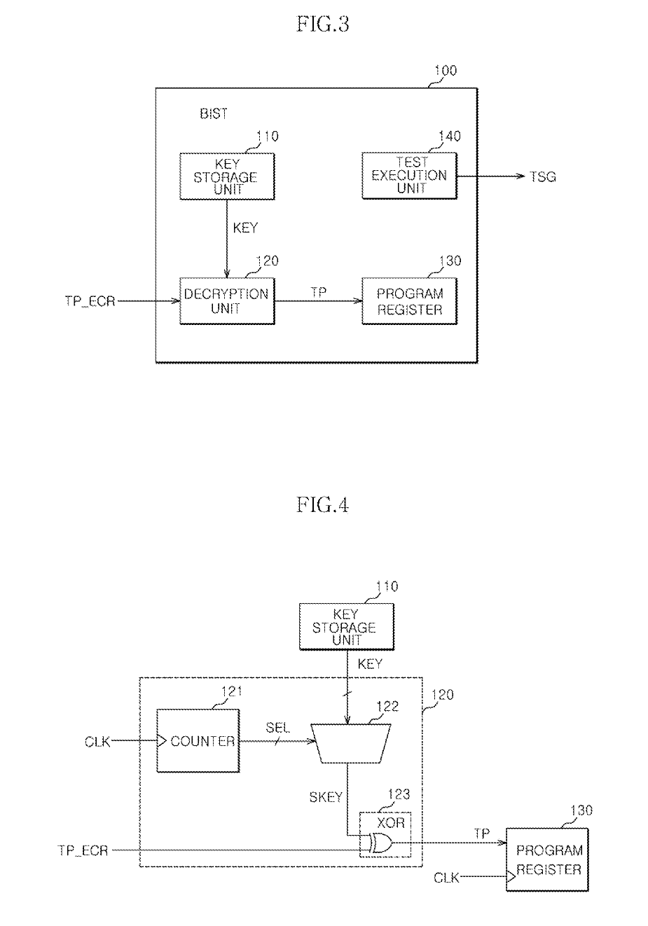

FIG. 2 is an example of a representation of a schematic block diagram of the semiconductor device 10 of FIG. 1.

The semiconductor device 10 may include the BIST 100 and an internal circuit 200.

The BIST 100 may receive an encrypted test program TP_ECR from an external apparatus. The BIST 100 may decrypt the encrypted test program TP_ECR using an embedded encryption key KEY and generate a test signal TSG based on the decrypted test program. The test signal TSG may include a test command, a test address, and test data, for example. The BIST 100 may control the operation of the internal circuit 200 through the test signal TSG. The BIST 100 may receive an operation execution result RSP of the internal circuit 200 according to the test signal TSG from the internal circuit 200. The BIST 100 may output the received operation execution result RSP to the external apparatus as a test result TRES.

The internal circuit 200 may perform an internal operation set in response to the test signal TSG and output the operation execution result RSP to the BIST 100. The internal circuit 200 may include a memory region 210.

FIG. 3 is an example of a representation of a block diagram of the BIST 100 illustrated in FIG. 2.

The BIST 100 may include a key storage unit 110, a decryption unit 120, a program register 130, and a test execution unit 140.

The key storage unit 110 may store an encryption key KEY. The key storage unit 110 may include a fuse circuit, for example. When the encrypted test program TP_ECR is received from an external apparatus, the key storage unit 110 may provide the stored encryption key KEY to the decryption unit 120.

The decryption unit 120 may decrypt the encrypted test program TP_ECR. The decryption unit 120 may decrypt the encrypted test program TP_ECR based on the encryption key KEY. For example, the decryption unit 120 may decrypt the encrypted test program TP_ECR by performing a logic operation on the encrypted test program TP_ECR and the encryption key KEY. The decryption unit 120 may output the decrypted test program TP to the program register 130.

The program register 130 may store the decrypted test program TP. The program register 130 may be referred to by the test execution unit 140.

The test execution unit 140 may generate the test signal TSG by driving the decrypted test program TP. The decrypted test program TP may include code for generating the test signal TSG. Although not illustrated, the test execution unit 140 may receive the operation execution result RSP that has responded to the test signal TSG from the internal circuit (200 of FIG. 2), may generate the test result TRES, and may output the generated test result TRES to the external apparatus.

FIG. 4 is a diagram illustrating an example of a representation of some elements of the BIST 100 illustrated in FIG. 3. Referring to FIG. 4, the decryption unit 120 may receive the encrypted test program TP_ECR through an interface using a serial method, for example.

The decryption unit 120 may include a counter 121, a multiplexer 122, and an operation unit 123.

The counter 121 may output a key selection code SEL to the multiplexer 122. The counter 121 may output a key selection code SEL to the multiplexer 122 in response to a clock signal CLK. For example, the counter 121 may count the toggle of the clock signal CLK and output a result of the counting as the key selection code SEL.

The multiplexer 122 may output the encryption key KEY, read from the key storage unit 110, as, for example, a serial-converted encryption key SKEY. The multiplexer 122 may output the encryption key KEY as the serial-converted encryption key SKEY in response to the key selection code SEL.

The operation unit 123 may perform logic operation on the encrypted test program TP_ECR and the serial-converted encryption key SKEY and may, for example, serially output the decrypted test program TP. For example, if a previous encryption process for a test program has been performed through exclusive OR operation of the test program and an encryption key, the operation unit 123 may include an exclusive OR (XOR) gate.

The program register 130 may store the decrypted test program TP. The program register 130 may store the decrypted test program TP in response to a clock signal CLK. For example, the program register 130 may include a shift register.

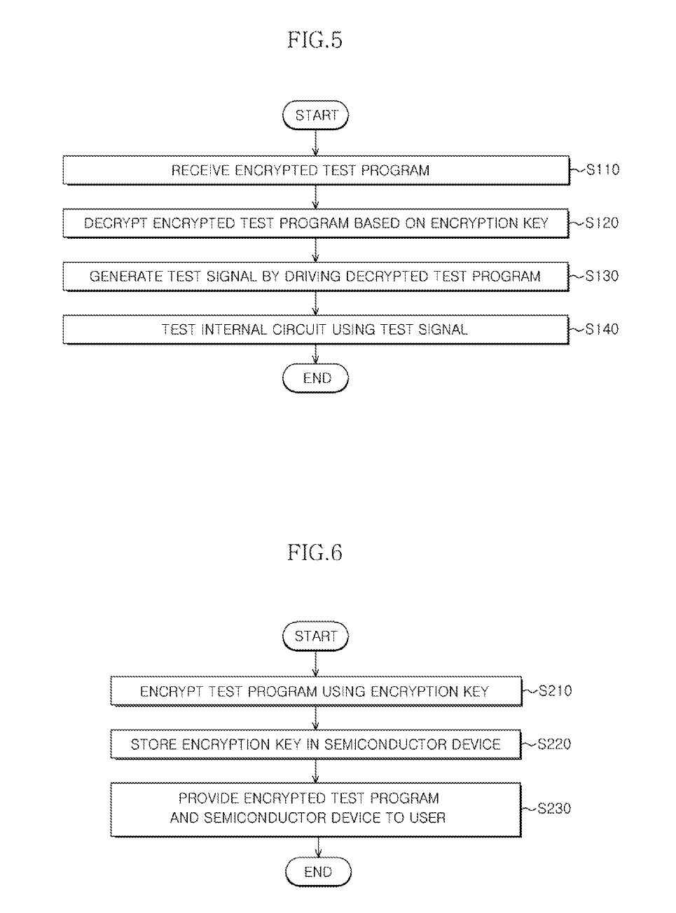

FIG. 5 is a flowchart illustrating an example of a representation of a test method of the semiconductor device in accordance with various embodiments. A test method of the semiconductor device 10 using the encrypted test program TP_ECR is described below with reference to FIGS. 2, 3, and 5.

At step S110, the BIST 100 may receive the encrypted test program TP_ECR from an external apparatus.

At step S120, the BIST 100 may decrypt the encrypted test program TP_ECR based on the encryption key KEY. The encryption key KEY may be read from the key storage unit 110 of the BIST 100. The decrypted test program TP may be stored in the program register 130.

At step S130, the BIST 100 may generate the test signal TSG by driving the decrypted test program TP. The test signal TSG may include a test command for controlling an internal operation of the internal circuit 200, a test address, and/or test data.

At step S140, the BIST 100 may test the internal circuit 200 using the test signal TSG. The BIST 100 may send the test signal TSG to the internal circuit 200. The BIST 100 may receive an operation execution result RSP from the internal circuit 200. The BIST 100 may output the received operation execution result RSP to the external apparatus as a test result TRES.

FIG. 6 is a flowchart illustrating an example of a representation of a method of maintaining the security for a semiconductor device in accordance with various embodiments.

At step S210, a manufacturer may encrypt a test program using an encryption key.

At step S220, the manufacturer may store the encryption key in a semiconductor device. The encryption key may be stored in a fuse circuit, for example.

At step S230, the manufacturer may provide the encrypted test program and the semiconductor device to a user. In order to test the semiconductor device, the user may input the encrypted test program to the semiconductor device. An analysis of the test program by the user can be effectively blocked because the test program of the user has been encrypted.

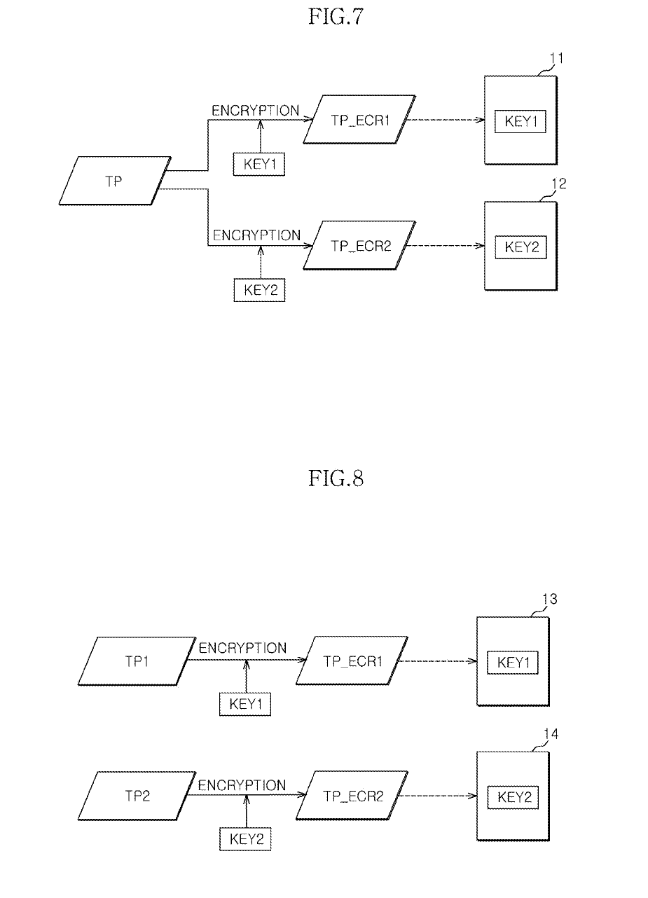

FIGS. 7 and 8 are diagrams illustrating examples of representations of test methods of semiconductor devices in accordance with an embodiment.

FIG. 7 illustrates a process of encrypting a test program TP using different encryption keys KEY1 and KEY2. The test program TP may be encrypted using first and second encryption keys KEY1 and KEY2. The encrypted test program may be generated differently depending on an encryption key used in an encryption process. A first encrypted test program TP_ECR1 encrypted using an encryption key KEY1 may be decrypted without an error only when the first encrypted test program TP_ECR1 is input to a semiconductor device 11 including the encryption key KEY1. A second encrypted test program TP_ECR2 encrypted using an encryption key KEY2 may be decrypted without an error only when the second encrypted test program TP_ECR2 is input to a semiconductor device 12 including the encryption key KEY2. A semiconductor device may test normally only when the semiconductor device receives a test program encrypted by an encryption key stored therein.

In some embodiments, an encryption key may be differently assigned to each user. A different encryption key may be assigned to each user although the encryption key is used to encrypt the same test program TP. A user may be supplied with a semiconductor device for storing an encryption key assigned thereto and a corresponding encrypted test program.

The security of a test program may be effectively maintained because the same test program TP is provided to several users as different and encrypted test programs as described above.

FIG. 8 illustrates a process of encrypting test programs TP1 and TP2, corresponding to different test patterns using different encryption keys KEY1 and KEY2. First and second test programs TP1 and TP2 may respectively correspond to different test patterns. The First and second test programs TP1 and TP2 may be respectively encrypted using the first and the second encryption keys KEY1 and KEY2. For example, a test program corresponding to one test pattern may be encrypted using only one encryption key.

Different encryption keys may be assigned to users or the test programs TP1 and TP2. A user may be supplied with a semiconductor device for storing an encryption key assigned thereto and a corresponding encrypted test program.

It may be assumed, for example, that a first encryption key has been assigned to a first user and a second encryption key has been assigned to a second user. For example, a first encrypted test program TP_ECR1 and a first semiconductor device 13 may be supplied to the first user. For example, a second encrypted test program TP_ECR2 and a second semiconductor device 14 may be supplied to the second user. For example, although the first user receives the second encrypted test program TP_ECR2 from the second user in order to test the first semiconductor device 13 using a test pattern by which a test has not been performed by the first user, the first user may obtain a desired result because the first semiconductor device 13 does not have the ability to decrypt the second encrypted test program TP_ECR2, that is, the first semiconductor device 13 does not include the second encryption key KEY2. That is, in accordance with an embodiment, an effect that maintains the security of a test program may be further improved because the distribution of the test program between users is limited.

FIG. 9 is a flowchart illustrating an example of a representation of a method of maintaining the security of the semiconductor device in accordance with an embodiment.

At step S310, a manufacturer may configure an encryption key corresponding to a user. The manufacturer may assign a specific encryption key to the user.

At step S320, the manufacturer may encrypt a test program using the configured encryption key.

At step S330, the manufacturer may store the configured encryption key in a semiconductor device.

At step S340, the manufacturer may provide the encrypted test program and the semiconductor device to the user.

The test circuit of the semiconductor device provided to, for example, the user in accordance with various embodiments may receive an encrypted test program from an external apparatus, may decrypt the received encrypted test program, and may autonomously perform a test. Since a test program is encrypted and provided, a risk that a core technology of the semiconductor device provided to, for example, the user may leak through an analysis of the test program may be removed.

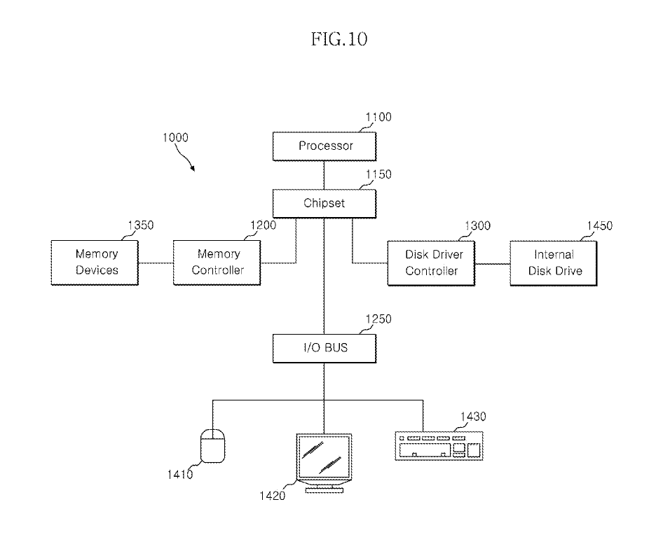

The semiconductor device discussed above (see FIGS. 1-9) are particular useful in the design of memory devices, processors, and computer systems. For example, referring to FIG. 10, a block diagram of a system employing the semiconductor device in accordance with the embodiments are illustrated and generally designated by a reference numeral 1000. The system 1000 may include one or more processors or central processing units (“CPUs”) 1100. The CPU 1100 may be used individually or in combination with other CPUs. While the CPU 1100 will be referred to primarily in the singular, it will be understood by those skilled in the art that a system with any number of physical or logical CPUs may be implemented.

A chipset 1150 may be operably coupled to the CPU 1100. The chipset 1150 is a communication pathway for signals between the CPU 1100 and other components of the system 1000, which may include a memory controller 1200, an input/output (“I/O”) bus 1250, and a disk drive controller 1300. Depending on the configuration of the system, any one of a number of different signals may be transmitted through the chipset 1150, and those skilled in the art will appreciate that the routing of the signals throughout the system 1000 can be readily adjusted without changing the underlying nature of the system.

As stated above, the memory controller 1200 may be operably coupled to the chipset 1150. The memory controller 1200 may include at least one semiconductor device as discussed above with reference to FIGS. 1-9. Thus, the memory controller 1200 can receive a request provided from the CPU 1100, through the chipset 1150. In alternate embodiments, the memory controller 1200 may be integrated into the chipset 1150. The memory controller 1200 may be operably coupled to one or more memory devices 1350. In an embodiment, the memory devices 1350 may include the at least one semiconductor device as discussed above with relation to FIGS. 1-9, the memory devices 1350 may include a plurality of word lines and a plurality of bit lines for defining a plurality of memory cells. The memory devices 1350 may be any one of a number of industry standard memory types, including but not limited to, single inline memory modules (“SIMMs”) and dual inline memory modules (“DIMMs”). Further, the memory devices 1350 may facilitate the safe removal of the external data storage devices by storing both instructions and data.

The chipset 1150 may also be coupled to the I/O bus 1250. The I/O bus 1250 may serve as a communication pathway for signals from the chipset 1150 to I/O devices 1410, 1420 and 1430. The I/O devices 1410, 1420 and 1430 may include a mouse 1410, a video display 1420, or a keyboard 1430. The I/O bus 1250 may employ any one of a number of communications protocols to communicate with the I/O devices 1410, 1420, and 1430. Further, the I/O bus 1250 may be integrated into the chipset 1150.

The disk drive controller 1450 (i.e., internal disk drive) may also be operably coupled to the chipset 1150. The disk drive controller 1450 may serve as the communication pathway between the chipset 1150 and one or more internal disk drives 1450. The internal disk drive 1450 may facilitate disconnection of the external data storage devices by storing both instructions and data. The disk drive controller 1300 and the internal disk drives 1450 may communicate with each other or with the chipset 1150 using virtually any type of communication protocol, including all of those mentioned above with regard to the I/O bus 1250.

It is important to note that the system 1000 described above in relation to FIG. 10 is merely one example of a system employing the semiconductor device as discussed above with relation to FIGS. 1-9. In alternate embodiments, such as cellular phones or digital cameras, the components may differ from the embodiments illustrated in FIG. 10.

While various embodiments have been described above, it will be understood to those skilled in the art that the embodiments described are by way of example only. Accordingly, the circuit and method described herein should not be limited based on the described embodiments.

What is claimed is:

1. A test method of a semiconductor device, comprising:
receiving a first encrypted test program externally from the semiconductor device;
decrypting the first encrypted test program based on an encryption key; and
generating a first test signal by driving the decrypted first test program.

2. The test method of claim 1, further comprising reading the encryption key from an embedded key storage unit included in the semiconductor device.

3. The test method of claim 1, further comprising storing the first decrypted test program in a program register.

4. The test method of claim 1, further comprising testing an internal circuit of the semiconductor device using the first test signal.

5. The test method of claim 1, further comprising encrypting a first test program into the first encrypted test program using the encryption key.

6. The test method of claim 1, further comprising:
receiving a second encrypted test program externally from the semiconductor device;
decrypting the second encrypted test program based on the encryption key; and
generating a second test signal by driving the second decrypted test program,
wherein the first and the second encrypted test programs correspond to different test patterns.

7. The test method of claim 6, further comprising encrypting a second test program into the second encrypted test program using the encryption key.

8. A test circuit of a semiconductor device, comprising:
a decryption unit configured to receive an encrypted test program externally from the semiconductor device and decrypt the encrypted test program based on an encryption key; and
a test execution unit configured to generate a test signal by driving the decrypted test program.

9. The test circuit of claim 8, further comprising a key storage unit configured for storing the encryption key.

10. The test circuit of claim 9, wherein the decryption unit comprises:
a counter configured to count a toggle of a clock signal and output a result of the counting as a key selection code;
a multiplexer configured to serially convert the encryption key output by the key storage unit in response to the key selection code and output the serial-converted encryption key; and
an operation unit configured to perform a logic operation on the encrypted test program and the serial-converted encryption key and output the decrypted test program.

11. The test circuit of claim 10, wherein the decryption unit is configured to receive the encrypted test program an interface using a serial method.

12. The test circuit of claim 10, further comprising a program register configured to store the decrypted test program.

13. The test circuit of claim 8, wherein the decrypted test program comprises a code for generating the test signal.

14. A test method of a semiconductor device, comprising:
generating a first encrypted test program by encrypting a test program using a first encryption key;
storing the first encryption key in a first semiconductor device; and
receiving the first encrypted test program externally from the semiconductor device by a test circuit located within the first semiconductor device.

15. The test method of claim 14, wherein the first encryption key stored in the first semiconductor device is used in a process of decrypting, by the test circuit, the first encrypted test program.

16. The test method of claim 14, wherein the first encryption key is stored in a fuse circuit and is read from the fuse circuit when the first encrypted test program is received by the test circuit.

17. The test method of claim 14, wherein the test program comprises a code for generating the test signal to control an internal operation of the first semiconductor device.

18. The test method of claim 14, further comprising generating a plurality of encrypted test programs by encrypting a plurality of respective test programs respectively corresponding to a plurality of test patterns using the first encryption key.

19. The test method of claim 14, further comprising:
generating a second encrypted test program by encrypting the test program using a second encryption key; and
storing the second encryption key in a second semiconductor device.

20. The test method of claim 19, wherein the first and the second encryption keys are differently assigned for each user.
